(19) United States
(12) Patent Application Publication
(10) Pub. No.: US 2021/0266923 A1
(43) Pub. Date: Aug. 26, 2021

(54) Generating Resource Allocation Coordination Information for Sidelink Communications

(71) Applicant: QUALCOMM Incorporated, San Diego, CA (US)

(72) Inventors: Gabi SARKIS, San Diego, CA (US); Sudhir Kumar BAGHEL, Hillsborough, NJ (US); Kapil GULATI, Belle Mead, NJ (US); Tien Viet NGUYEN, Bridgewater, NJ (US); Seyedkianoush HOSSEINI, San Diego, CA (US); Shuanshuan WU, San Diego, CA (US); Junyi LI, Franklin Park, NJ (US); Wanshi CHEN, San Diego, CA (US)

(21) Appl. No.: 17/172,799

(22) Filed: Feb. 10, 2021

Related U.S. Application Data
(60) Provisional application No. 62/980,393, filed on Feb. 23, 2020.

(51) Int. Cl. H04W 72/12; H04W 76/14; H04W 72/02; H04W 72/04

(52) U.S. Cl. CPC H04W 72/121; H04W 76/14; H04W 72/1289; H04W 72/042; H04W 72/02

(57) ABSTRACT

Embodiments include systems and methods for sidelink communications. In embodiments, a processor of a wireless device may generate a message, which may be a control channel message, including resource allocation coordination information. The processor may transmit the configured message including the resource allocation coordination information to the second wireless device.

### RELATED APPLICATIONS

This application claims the benefit of priority to U.S. Provisional Application No. 62/980,393 entitled “Generating Coordination Information for Sidelink Communications” filed Feb. 23, 2020, the entire contents of which are hereby incorporated by reference for all purposes

### BACKGROUND

In modern wireless communication technologies, such as Fifth Generation (5G) protocols, wireless devices of many different makes and classes may be configured to perform direct device-to-device communications via a “sidelink” communication path. Sidelink communications may be conducted without the support of a communication network, referred to as Mode 2 operation. In Mode 2 operation, wireless devices must contend for communication resources (e.g., time slots and frequency channels) used for sidelink communications. Sidelink communications include logical sidelink channels for wireless devices to exchange and coordinate settings and data to control signaling and coordinate the use of the allocated frequencies. The more information a wireless device has about the availability of sidelink communication resources, the more efficiently the wireless device may perform sidelink communications.

### SUMMARY

Various aspects include systems and methods for supporting sidelink communication that may be performed by a processor of a wireless device. Various aspects may include generating a message including resource allocation coordination information, and transmitting the message including the resource allocation coordination information to a second wireless device. In some embodiments, the resource allocation coordination information may enable a second wireless device to avoid a sidelink communication resource collision.

In some embodiments, generating the message including the resource allocation coordination information may include generating a Medium Access Control (MAC) control element (CE) that includes the resource allocation coordination information. In some embodiments, generating the message including the resource allocation coordination information may include configuring a Sidelink Control Information (SCI) message to include the resource allocation coordination information. Some embodiments may include receiving, from a third wireless device, information about a sidelink communication resource reservation made by the third wireless device, and determining the resource allocation coordination information based on the information received from the third wireless device.

In some embodiments, generating the message including the resource allocation coordination information may include configuring the message to include a map of available resources and occupied resources. In some embodiments, generating the message including the resource allocation coordination information may include configuring the message to include one or more of a list of occupied resources or a list of available resources. In some embodiments, generating the message including the resource allocation coordination information may include configuring the message to include one or more of a list of preferred resources for transmissions by the second wireless device to the wireless device, or a list of resources to avoid for transmissions by the second wireless device to the wireless device.

In some embodiments, generating the message including the resource allocation coordination information may include configuring the message to include one or more of a location of the wireless device, a priority associated with the wireless device, or a timestamp indicating when the resource allocation coordination information was determined. In some embodiments, generating the message including the resource allocation coordination information may include configuring the message to include per-resource information that includes one or more of a signal strength measurement associated with a resource reservation, a source identifier associated with a resource reservation, a destination identifier associated with a resource reservation, a hybrid automatic repeat request (HARQ) identifier associated with a resource reservation, a priority associated with a resource reservation, a location of a transmitter reserving a resource, a reservation time period, or a demodulation reference signal (DMRS) pattern of a transmission associated with a resource reservation.

Further aspects may include a wireless device having a transceiver and a processor coupled to the transceiver and configured to perform one or more operations of the methods summarized above. Further aspects may include a non-transitory processor-readable storage medium having stored thereon processor-executable instructions configured to cause a processor of a wireless device to perform operations of the methods summarized above. Further aspects include a wireless device having means for performing functions of the methods summarized above. Further aspects include a system on chip for use in a wireless device that includes a processor configured to perform one or more operations of the methods summarized above. Further aspects include a system in a package that includes two systems on chip for use in a wireless device that includes a processor configured to perform one or more operations of the methods summarized above.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIG. 1A is a system block diagram illustrating an example communication system suitable for implementing any of the various embodiments.

FIG. 1B is a system and component block diagram illustrating a system of components and support systems suitable for implementing various embodiments.

FIG. 2 is a component block diagram illustrating an example computing and wireless modem system suitable for implementing any of the various embodiments.

FIG. 3 is a component block diagram illustrating a software architecture including a radio protocol stack for the user and control planes in wireless communications suitable for implementing any of the various embodiments.

FIG. 4 is a component block diagram illustrating a system configured for sidelink communications in accordance with various embodiments.

FIG. 5 is a process flow diagram illustrating a method of sidelink communications according to various embodiments.

FIGS. 6A, 6B, 6C, 6D, 6E, and 6F are process flow diagrams illustrating operations that may be performed by a processor of a wireless device as part of a method of sidelink communications according to various embodiments.

FIG. 7 is a component block diagram of a network computing device suitable for use with various embodiments.

FIG. 8 is a component block diagram of a wireless device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include systems and methods for supporting sidelink communications between two or more wireless devices by providing communications using messages to enable a first wireless device to provide sidelink communication resource allocation coordination information to a second wireless device that can be used to reserve sidelink communication resources that reduce the potential for communication collisions in sidelink messages received by the first wireless device. In some embodiments, the messages may be control channel messages.

The term “wireless device” is used herein to refer to any one or all of cellular telephones, smartphones, wireless communication elements within autonomous and semiautonomous vehicles, intelligent highway computing devices including road side units, highway sensors, portable computing devices, laptop computers, tablet computers, multimedia Internet-enabled cellular telephones, medical devices and equipment, biometric sensors/devices, wearable devices, wireless-network enabled Internet of Things (IoT) devices including smart meters/sensors, industrial manufacturing equipment, large and small machinery and appliances for home or enterprise use, wireless devices affixed to or incorporated into various mobile platforms, global positioning system devices, and similar electronic devices that include a memory, wireless communication components and a programmable processor.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. An SIP may also include multiple independent SOCs coupled together via high speed communication circuitry and packaged in close proximity, such as on a single motherboard or in a single wireless device. The proximity of the SOCs facilitates high speed communications and the sharing of memory and resources.

The term “multicore processor” may be used herein to refer to a single integrated circuit (IC) chip or chip package that contains two or more independent processing cores (e.g., CPU core, Internet protocol (IP) core, graphics processor unit (GPU) core, etc.) configured to read and execute program instructions. A SOC may include multiple multicore processors, and each processor in an SOC may be referred to as a core. The term “multiprocessor” may be used herein to refer to a system or device that includes two or more processing units configured to read and execute program instructions.

Allocation of sidelink communication resources (i.e., time domain resources such as time slots, and frequency domain resources such as channels, sub-channels, frequencies, or frequency ranges) used to transmit sidelink messages is reservation-based. Sidelink resources may be allocated in units of sub-channels in the frequency domain, and may be limited to one slot in the time domain. A wireless device may transmit a reservation message to reserve resources in a current time slot and in up to two future time slots. Wireless devices transmit reservation messages in sidelink control information (SCI) messages. Sidelink communication reservations may be made in a window of a designated number of logical slots (such as 32 logical slots). Various systems may support aperiodic and periodic reservations. A period may be signaled in the SCI, and may be of a configurable duration (e.g., 0 ms-1000 ms). Such periodic resource reservations and signaling may also be disabled in the communication network.

In Mode 2 operations, a wireless device may identify candidate resources by detecting the presence and measuring the strength of a wireless signal, excluding occupied resources (i.e., subchannels in which wireless signals are detected with a strength exceeding a threshold), and selecting candidate resource from available resources (i.e., sideline communication resources that have not been reserved by another wireless device). Conventionally, a wireless device may decode SCI to determine whether a resource is available or has been reserved. The wireless device may reserve an un-reserved resource. To identify sidelink communication resources that are not occupied, a wireless device may measure a signal strength (such as a Reference Signal Receive Power) for reservations in decoded SCI information. The signal strength of the transmission associated with an SCI reserving resources may be projected onto the resource selection window. Resource reservations are also associated with a priority, and a reservation may be pre-empted by a higher-priority reservation, which may trigger the resource selection process again.

A sidelink communication resource collision occurs when a two or more wireless devices select or contend for the same communication resources. The process of identifying available sidelink communication resources and reserving resources prior to transmitting a sidelink message is designed to avoid collisions. However, the information available to wireless devices for identifying unoccupied sidelink resources is limited to received signals and measurements. Conventionally a wireless device is able to determine whether sidelink communication resources are available nearby; however, the wireless device is unable to make that determination at the location of another wireless device. Thus, it is possible that a wireless device may reserve and then transmit on sidelink communication resources that collide at a receiving wireless device with messages or transmissions from other devices. The more information a wireless device has about the availability of sidelink communication resources, the more efficiently the wireless device may identify and use available sidelink communication resources that will not collide with other transmissions at receiving wireless devices.

Various embodiments enable improved performance of sidelink communications by a first wireless device providing to a second wireless device information regarding available sidelink communication resources observed by the first wireless device. As used herein, the term “resource allocation coordination information” includes information that the first wireless device provides to the second wireless device about the available sidelink communication resources that are useful for the second wireless device to communicate with the first wireless device via sidelink communications. For example, resource allocation coordination information may include a signal strength measurement associated with a resource reservation, a source identifier associated with a resource reservation, a destination identifier associated with a resource reservation, a hybrid automatic repeat request (HARQ) identifier associated with a resource reservation, a priority associated with a resource reservation, a location of a transmitter reserving a resource, a reservation time period, and/or a demodulation reference signal (DMRS) pattern of a transmission associated with a resource reservation.

In various embodiments, a first wireless device may generate a message including a variety of such information, which is referred to herein as “resource allocation coordination information,” and transmit the configured message including the resource allocation coordination information to the second wireless device. In some embodiments, the message may be a control message. In some embodiments, the included resource allocation coordination information may, for example, enable a second wireless device to avoid a sidelink communication resource collision. For example, using the resource allocation coordination information, the wireless device may determine that a signal is present in a communication resource, may determine a signal strength, may receive reservation information, or may determine a priority associated with reservation information from one or more other wireless devices, as well as a variety of other information. In some embodiments, the included resource allocation coordination information may enable or improve half-duplex sidelink communication. In some embodiments, use of the included resource allocation coordination information may enable the second wireless device to save power by, for example, reducing sensing operations to determine available sidelink communication resources. The first wireless device may encode some or all of such resource allocation coordination information in a message, which may be a control message, and transmit the message to a second wireless device. The second wireless device may use the resource allocation coordination information thus provided to select an available sidelink communication resource.

In some embodiments, the wireless device may configure a Medium Access Control (MAC) control element (CE) to include the resource allocation coordination information. In some embodiments, the wireless device may configure an SCI message (such as an SCI 2 message) to include the resource allocation coordination information. The MAC-CE may be a larger data carrier than the SCI message, and thus may provide more flexibility in the types of information, and how much information, that can be encoded than possible in SCI messages. In some embodiments, the wireless device may receive from a third wireless device information about a sidelink communication resource reservation made by the third wireless device, and may determine the resource allocation coordination information based on the information received from the third wireless device.

The wireless device may encode the resource allocation coordination information in a MAC-CE message in variety of formats or ways. In some embodiments, the wireless device may configure the message, which may be a control channel message, to include a map (such as a bitmap) of available resources and occupied resources. In some embodiments, the wireless device may configure the message to include one or more of a list of occupied resources or a list of available resources. In some embodiments, the wireless device may configure the message to include one or more of a list of preferred resources for transmissions by the second wireless device to the wireless device, or a list of resources to avoid for transmissions by the second wireless device to the wireless device. In some embodiments, the wireless device may configure the message to include any combination of the above information in any format.

In some embodiments, the wireless device may configure the message, which may be a control message, to include one or more of a location of the wireless device, a priority associated with the wireless device, or a timestamp indicating when the resource allocation coordination information was determined.

In some embodiments, the wireless device may configure the message, which may be a control message, to include resource allocation coordination information per-resource. For example, the wireless device may configure the message per-resource information including one or more of a signal strength measurement associated with a resource reservation, a source identifier associated with a resource reservation, a destination identifier associated with a resource reservation, a HARQ identifier associated with a resource reservation, a priority associated with a resource reservation, a location of a transmitter reserving a resource, a reservation time period, or a DMRS pattern of a transmission associated with a resource reservation. In some embodiments, the wireless device may configure the message to include any combination of the above information in any format.

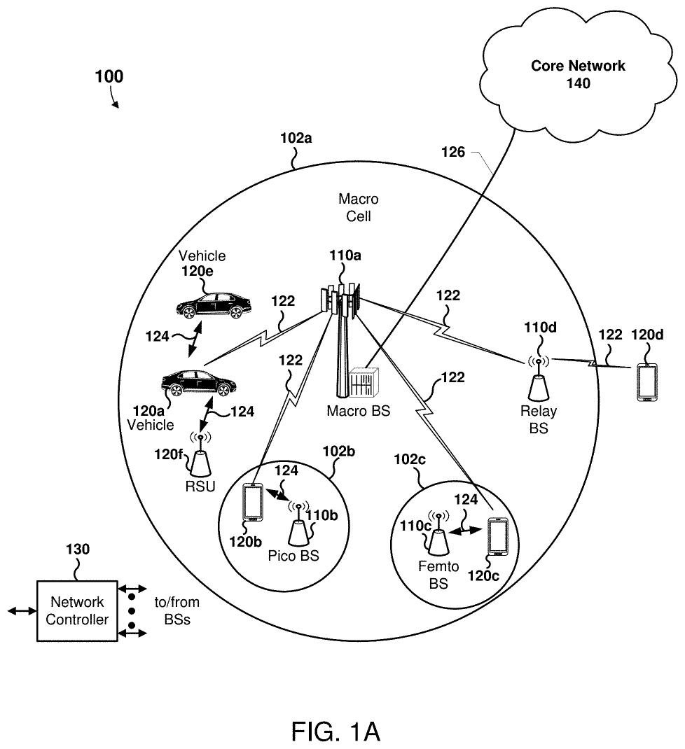

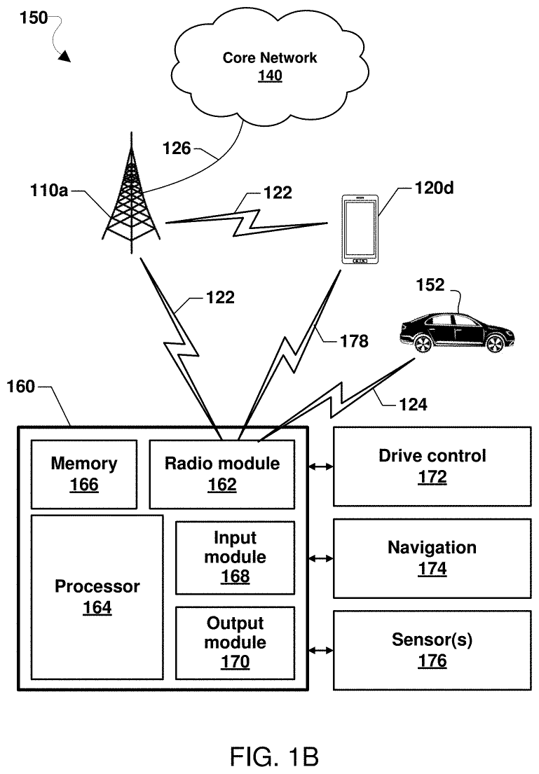

FIG. 1 is a system block diagram illustrating an example communication system 100 suitable for implementing any of the various embodiments. The communications system 100 may be an 5G New Radio (NR) network, or any other suitable network such as Long Term Evolution (LTE) network.

The communications system 100 may include a heterogeneous network architecture that includes a core network 140 and a variety of wireless devices (illustrated as vehicles 120a and 120e, a road side unit 120f, and mobile devices 120b-120d, all referred to herein generally as “wireless devices”). The communications system 100 may also include a number of base stations (illustrated as the BS 110a, the BS 110b, the BS 110c, and the BS 110d) and other network entities. A base station is an entity that communicates with wireless devices (mobile devices), and also may be referred to as an NodeB, a Node B, an LTE evolved nodeB (eNB), an access point (AP), a radio head, a transmit receive point (TRP), a New Radio base station (NR BS), a 5G NodeB (NB), a Next Generation NodeB (gNB), or the like. Each base station may provide communication coverage for a particular geographic area. In 3GPP, the term “cell” can refer to a coverage area of a base station, a base station subsystem serving this coverage area, or a combination thereof, depending on the context in which the term is used.

A base station 110a-110d may provide communication coverage for a macro cell, a pico cell, a femto cell, another type of cell, or a combination thereof. A macro cell may cover a relatively large geographic area (for example, several kilometers in radius) and may allow unrestricted access by wireless devices with service subscription. A pico cell may cover a relatively small geographic area and may allow unrestricted access by wireless devices with service subscription. A femto cell may cover a relatively small geographic area (for example, a home) and may allow restricted access by wireless devices having association with the femto cell (for example, wireless devices in a closed subscriber group (CSG)). A base station for a macro cell may be referred to as a macro BS. A base station for a pico cell may be referred to as a pico BS. A base station for a femto cell may be referred to as a femto BS or a home BS. In the example illustrated in FIG. 1, a base station 110a may be a macro BS for a macro cell 102a, a base station 110b may be a pico BS for a pico cell 102b, and a base station 110c may be a femto BS for a femto cell 102c. A base station 110a-110d may support one or multiple (for example, three) cells. The terms “eNB”, “base station”, “NR BS”, “gNB”, “TRP”, “AP”, “node B”, “5G NB”, and “cell” may be used interchangeably herein.

In some examples, a cell may not be stationary, and the geographic area of the cell may move according to the location of a mobile base station. In some examples, the base stations 110a-110d may be interconnected to one another as well as to one or more other base stations or network nodes (not illustrated) in the communications system 100 through various types of backhaul interfaces, such as a direct physical connection, a virtual network, or a combination thereof using any suitable transport network

The base station 110a-110d may communicate with the core network 140 over a wired or wireless communication link 126. The wireless device 120a-120f may communicate with the base station 110a-110d over a wireless communication link 122.

The wired communication link 126 may use a variety of wired networks (e.g., Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communications system 100 also may include relay stations (e.g., relay BS 110d). A relay station is an entity that can receive a transmission of data from an upstream station (for example, a base station or a wireless device) and transmit the data to a downstream station (for example, a wireless device or a base station). A relay station also may be a wireless device that can relay transmissions for other wireless devices. In the example illustrated in FIG. 1, a relay station 110d may communicate with macro the base station 110a and the wireless device 120d in order to facilitate communications between the base station 110a and the wireless device 120d. A relay station also may be referred to as a relay base station, a relay base station, a relay, etc.

The communications system 100 may be a heterogeneous network that includes base stations of different types, for example, macro base stations, pico base stations, femto base stations, relay base stations, etc. These different types of base stations may have different transmit power levels, different coverage areas, and different impacts on interference in communications system 100. For example, macro base stations may have a high transmit power level (for example, 5 to 40 Watts) whereas pico base stations, femto base stations, and relay base stations may have lower transmit power levels (for example, 0.1 to 2 Watts).

A network controller 130 may couple to a set of base stations and may provide coordination and control for these base stations. The network controller 130 may communicate with the base stations via a backhaul. The base stations also may communicate with one another, for example, directly or indirectly via a wireless or wireline backhaul.

The wireless devices 120a-120f may be dispersed throughout communications system 100, and each wireless device may be stationary (e.g., a road side unit 120f) or mobile (e.g., vehicles 120d, 120e).

A macro base station 110a may communicate with the communication network 140 over a wired or wireless communication link 126. The wireless devices 120a, 120b, 120c may communicate with a base station 110a-110d over a wireless communication link 122.

The wireless communication links 122, 124 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (e.g., NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links 122, 124 within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block”) may be 12 subcarriers (or 180 kHz). Consequently, the nominal Fast File Transfer (FFT) size may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

While descriptions of some embodiments may use terminology and examples associated with LTE technologies, various embodiments may be applicable to other wireless communications systems, such as a new radio (NR) or 5G network. NR may utilize OFDM with a cyclic prefix (CP) on the uplink (UL) and downlink (DL) and include support for half-duplex operation using time division duplex (TDD). A single component carrier bandwidth of 100 MHz may be supported. NR resource blocks may span 12 sub-carriers with a sub-carrier bandwidth of 75 kHz over a 0.1 millisecond (ms) duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data. Beamforming may be supported and beam direction may be dynamically configured. Multiple Input Multiple Output (MIMO) transmissions with precoding may also be supported. MIMO configurations in the DL may support up to eight transmit antennas with multi-layer DL transmissions up to eight streams and up to two streams per wireless device. Multi-layer transmissions with up to 2 streams per wireless device may be supported. Aggregation of multiple cells may be supported with up to eight serving cells. Alternatively, NR may support a different air interface, other than an OFDM-based air interface.

Some wireless devices may be considered machine-type communications (MTC) or evolved or enhanced machine-type communications (eMTC) wireless devices. MTC and eMTC wireless devices include, for example, robots, drones, remote devices, sensors, meters, monitors, location tags, etc., that may communicate with a base station, another device (for example, remote device), or some other entity. A wireless node may provide, for example, connectivity for or to a network (for example, a wide area network such as Internet or a cellular network) via a wired or wireless communication link. Some wireless devices may be considered Internet-of-Things (IoT) devices or may be implemented as NB-IoT (narrowband Internet of things) devices. A wireless device 120a-e may be included inside a housing that houses components of the wireless device, such as processor components, memory components, similar components, or a combination thereof.

In general, any number of communication systems and any number of wireless networks may be deployed in a given geographic area. Each communications system and wireless network may support a particular radio access technology (RAT) and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between communications systems of different RATs. In some cases, NR or 5G RAT networks may be deployed.

In some implementations, two or more wireless devices 120a-120f (for example, illustrated as a first vehicle wireless device 120a, a second vehicle the wireless device 120e, and a road side unit (RSU) 120f) may communicate directly using one or more sidelink channels 124. Sidelink channels 124 enable communications without using a base station 110a-110d as an intermediary to communicate with one another. For example, the wireless devices 120a-120f may communicate using peer-to-peer (P2P) communications, device-to-device (D2D) communications, a vehicle-to-everything (V2X) protocol (which may include a vehicle-to-vehicle (V2V) protocol, a vehicle-to-infrastructure (V2I) protocol, vehicle-to-pedestrian (V2P), or similar protocol), a mesh network, or similar networks, or combinations thereof. In this case, processors in the wireless device 120a-120f may perform scheduling operations, resource selection operations, as well as other operations described elsewhere herein as being performed by the base station 110a.

FIG. 1B is a system and component block diagram illustrating a system 150 of components and support systems suitable for implementing various embodiments. With reference to FIGS. 1A and 1B, a vehicle (e.g., 120a) may include a control unit 160, which may include various circuits and devices used to control the operation of the vehicle 100 as well as communicate with other vehicles that are similarly equipped. In the example illustrated in FIG. 1B, the control unit 160 includes a radio module 162, a processor 164, memory 166, an input module 168, and an output module 170. The control unit 160 may be coupled to and configured to control drive control components 172, navigation components 174, and one or more sensors 176 of the vehicle (e.g., 120a).

The control unit 160 may include a processor 164 that may be configured with processor-executable instructions to control maneuvering, navigation, and/or other operations of the vehicle, including operations of various embodiments. The processor 164 may be coupled to the memory 166. The control unit 162 may include the input module 168, the output module 170, and the radio module 162.

The radio module 162 may be configured for wireless communications, including implementing operations of various embodiments. The radio module 162 may exchange wireless signals 122 with a base station and sidelink communication messages 124 with control units in other vehicles 152 and road side units (e.g., 120f). In some embodiments, the radio module 162 may also enable the vehicle (e.g., an infotainment system) to communicate with a wireless communication device 120d through a bidirectional wireless communication link 178, such as a Bluetooth wireless data link.

The input module 168 may receive sensor data from one or more vehicle sensors 176 as well as electronic signals from other components, including the drive control components 172 and the navigation components 174. The output module 170 may be used to communicate with or activate various components of the vehicle, including the drive control components 172, the navigation components 174, and the sensor(s) 176.

The control unit 160 may be coupled to the drive control components 172 to control physical elements of the vehicle related to maneuvering and navigation of the vehicle, such as the engine, motors, throttles, steering elements, flight control elements, braking or deceleration elements, and the like.

The control unit 160 may be coupled to the navigation components 174, and may receive data from the navigation components 174 and be configured to use such data to determine the present position and orientation of the vehicle, as well as an appropriate course toward a destination.

The processor 164 and/or the navigation components 174 may be configured to communicate with a core network 140 (e.g., the Internet) using a wireless connection 122 with a cellular data network base station 110a. The processor 164 may also be configured to perform a variety of software application programs by executing processor-executable instructions in an application layer as described herein.

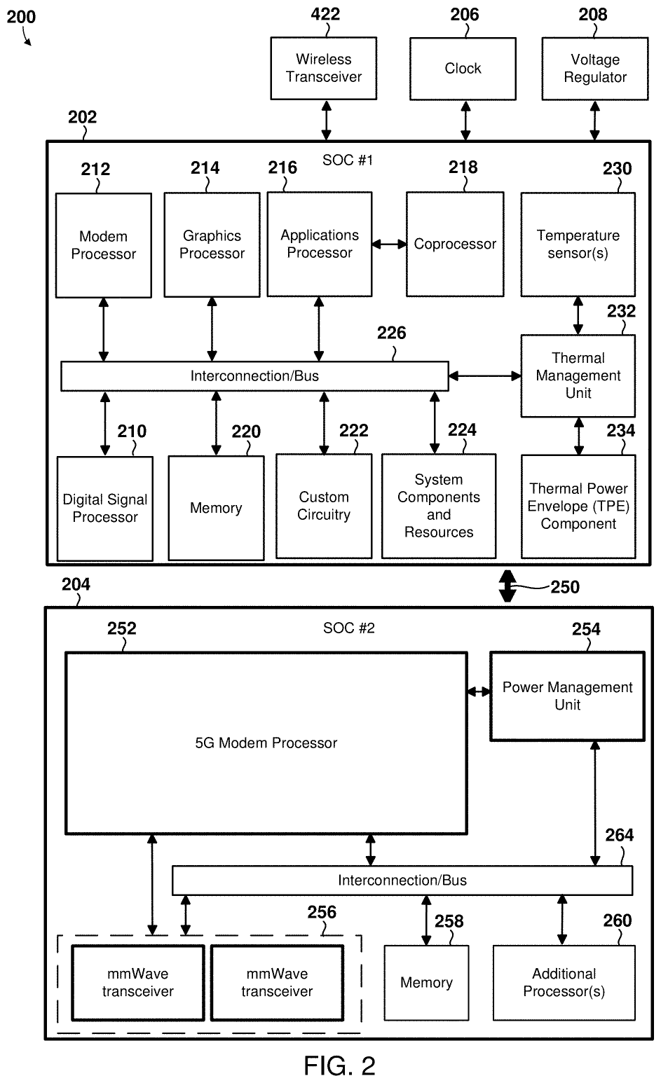

While the control unit 160 is described as including separate components, in some embodiments some or all of the components (e.g., the processor 164, the memory 166, the input module 168, the output module 170, and the radio module 162) may be integrated in a single device or module, such as a system-on-chip (SOC) or system-in-package (SIP) processing device, such as described with reference to FIG. 2. Such an SOC or SIP processing device may be configured for use in vehicles and be configured, such as with processor-executable instructions executing in the processor 164, to perform operations of various embodiments when installed into a vehicle.

In some implementations, the communication system 100 may include one or more devices configured to communicate as part of an intelligent transportation system (ITS). ITS technologies may increase intercommunication and safety for driver-operated vehicles and autonomous vehicles. The cellular vehicle-to-everything (C-V2X) protocol defined by the 3rd Generation Partnership Project (3GPP) supports ITS technologies and serves as the foundation for vehicles to communicate directly with the communication devices around them.

C-V2X defines transmission modes that provide non-line-of-sight awareness and a higher level of predictability for enhanced road safety and autonomous driving. Such C-V2X transmission modes may include V2V, V2I, and V2P, and may utilize frequencies in a 5.9 gigahertz (GHz) spectrum that is independent of a cellular network. C-V2X transmission modes may also include vehicle-to-network communications (V2N) in mobile broadband systems and technologies, such as 3G mobile communication technologies (e.g., GSM evolution (EDGE) systems, CDMA 2000 systems, etc.), 4G communication technologies (e.g., LTE, LTE-Advanced, WiMAX, etc.), as well as 5G systems.

FIG. 2 is a component block diagram illustrating an example computing system 200 suitable for implementing any of the various embodiments. Various embodiments may be implemented on a number of single processor and multiprocessor computer systems, including a system-on-chip (SOC) or system in a package (SIP).

With reference to FIGS. 1A-2, the illustrated example SIP 200 includes a two SOCs 202, 204 coupled to a clock 206, a voltage regulator 208 and a wireless transceiver 422. In some embodiments, the first SOC 202 operate as central processing unit (CPU) of the wireless device that carries out the instructions of software application programs by performing the arithmetic, logical, control and input/output (I/O) operations specified by the instructions. In some embodiments, the second SOC 204 may operate as a specialized processing unit. For example, the second SOC 204 may operate as a specialized 5G processing unit responsible for managing high volume, high speed (e.g., 5 Gbps, etc.), and/or very high frequency short wave length (e.g., 28 GHz mmWave spectrum, etc.) communications.

The first SOC 202 may include a digital signal processor (DSP) 210, a modem processor 212, a graphics processor 214, an application processor 216, one or more coprocessors 218 (e.g., vector co-processor) connected to one or more of the processors, memory 220, custom circuity 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, a plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (e.g., FreeBSD, LINUX, OS X, etc.) and a processor that executes a second type of operating system (e.g., MICROSOFT WINDOWS 10). In addition, any or all of the processors 210, 212, 214, 216, 218, 252, 260 may be included as part of a processor cluster architecture (e.g., a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a wireless device. The system components and resources 224 and/or custom circuitry 222 may also include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates and/or implement a bus architecture (e.g., CoreConnect, AMBA, etc.). Communications may be provided by advanced interconnects, such as high-performance networks-on chip (NoCs).

The first and/or second SOCs 202, 204 may further include an input/output module (not illustrated) for communicating with resources external to the SOC, such as a clock 206 and a voltage regulator 208. Resources external to the SOC (e.g., clock 206, voltage regulator 208) may be shared by two or more of the internal SOC processors/cores.

In addition to the example SIP 200 discussed above, various embodiments may be implemented in a wide variety of computing systems, which may include a single processor, multiple processors, multicore processors, or any combination thereof

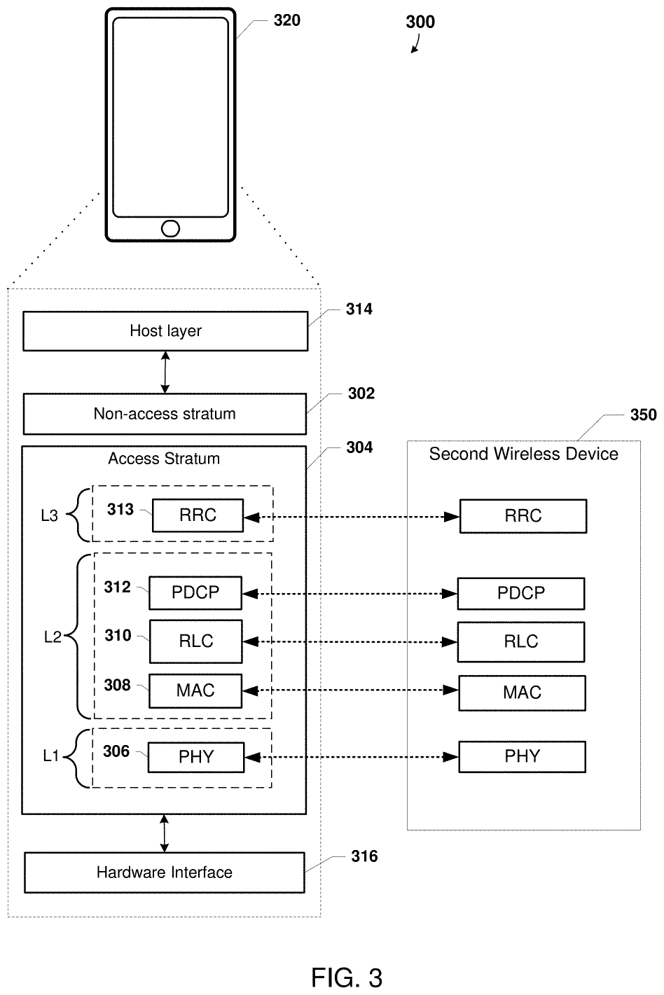

FIG. 3 is a component block diagram illustrating a software architecture 300 including a radio protocol stack for the user and control planes in wireless communications suitable for implementing any of the various embodiments. With reference to FIGS. 1-3, the wireless device 320 may implement the software architecture 300 to facilitate communications between the wireless device 320 (e.g., the wireless device 120a-120f, 200) and a second wireless device 350 (e.g., a vehicle wireless device 120d, a road side unit 120f, a base station 110a, etc.) of a communication system (e.g., 100). In various embodiments, layers in the software architecture 300 may form logical connections with corresponding layers in software of the second wireless device 350. The software architecture 300 may be distributed among one or more processors (e.g., the processors 212, 214, 216, 218, 252, 260). While illustrated with respect to one radio protocol stack, in a multi-SIM (subscriber identity module) wireless device, the software architecture 300 may include multiple protocol stacks, each of which may be associated with a different SIM (e.g., two protocol stacks associated with two SIMs, respectively, in a dual-SIM wireless communication device). While described below with reference to LTE communication layers, the software architecture 300 may support any of variety of standards and protocols for wireless communications, and/or may include additional protocol stacks that support any of variety of standards and protocols wireless communications.

The software architecture 300 may include a Non-Access Stratum (NAS) 302 and an Access Stratum (AS) 304. The NAS 302 may include functions and protocols to support packet filtering, security management, mobility control, session management, and traffic and signaling between a SIM(s) of the wireless device (e.g., SIM(s) 204) and its core network 140. The AS 304 may include functions and protocols that support communications between a SIM(s) (e.g., SIM(s) 204) and entities of supported access networks (e.g., a base station). In particular, the AS 304 may include at least three layers (Layer 1, Layer 2, and Layer 3), each of which may contain various sub-layers.

In the user and control planes, Layer 1 (L1) of the AS 304 may be a physical layer (PHY) 306, which may oversee functions that enable transmission and/or reception over the air interface. Examples of such physical layer 306 functions may include cyclic redundancy check (CRC) attachment, coding blocks, scrambling and descrambling, modulation and demodulation, signal measurements, MIMO, etc. The physical layer may include various logical channels, including a Physical Downlink Control Channel (PDCCH) and a Physical Downlink Shared Channel (PDSCH), or sidelink channels such as a Physical Sidelink Control Channel (PSCCH) and a Physical Sidelink Shared Channel (PSSCH).

In the user and control planes, Layer 2 (L2) of the AS 304 may be responsible for the link between the wireless device 320 and the second wireless device 350 over the physical layer 306. In the various embodiments, Layer 2 may include a media access control (MAC) sublayer 308, a radio link control (RLC) sublayer 310, and a packet data convergence protocol (PDCP) 312 sublayer, each of which form logical connections terminating at the second wireless device 350.

In the control plane, Layer 3 (L3) of the AS 304 may include a radio resource control (RRC) sublayer 3. While not shown, the software architecture 300 may include additional Layer 3 sublayers, as well as various upper layers above Layer 3. In various embodiments, the RRC sublayer 313 may provide functions including broadcasting system information, paging, and establishing and releasing an RRC signaling connection between the wireless device 320 and the second wireless device 350.

In various embodiments, the PDCP sublayer 312 may provide uplink functions including multiplexing between different radio bearers and logical channels, sequence number addition, handover data handling, integrity protection, ciphering, and header compression. In the downlink, the PDCP sublayer 312 may provide functions that include in-sequence delivery of data packets, duplicate data packet detection, integrity validation, deciphering, and header decompression.

In the uplink, the RLC sublayer 310 may provide segmentation and concatenation of upper layer data packets, retransmission of lost data packets, and Automatic Repeat Request (ARQ). In the downlink, while the RLC sublayer 310 functions may include reordering of data packets to compensate for out-of-order reception, reassembly of upper layer data packets, and ARQ.

In the uplink, MAC sublayer 308 may provide functions including multiplexing between logical and transport channels, random access procedure, logical channel priority, and hybrid-ARQ (HARQ) operations. In the downlink, the MAC layer functions may include channel mapping within a cell, de-multiplexing, discontinuous reception (DRX), and HARQ operations.

While the software architecture 300 may provide functions to transmit data through physical media, the software architecture 300 may further include at least one host layer 314 to provide data transfer services to various applications in the wireless device 320. In some embodiments, application-specific functions provided by the at least one host layer 314 may provide an interface between the software architecture and the general purpose processor 206.

In other embodiments, the software architecture 300 may include one or more higher logical layer (e.g., transport, session, presentation, application, etc.) that provide host layer functions. For example, in some embodiments, the software architecture 300 may include a network layer (e.g., IP layer) in which a logical connection terminates at a packet data network (PDN) gateway (PGW). In some embodiments, the software architecture 300 may include an application layer in which a logical connection terminates at another device (e.g., end user device, server, etc.). In some embodiments, the software architecture 300 may further include in the AS 304 a hardware interface 316 between the physical layer 306 and the communication hardware (e.g., one or more radio frequency (RF) transceivers).

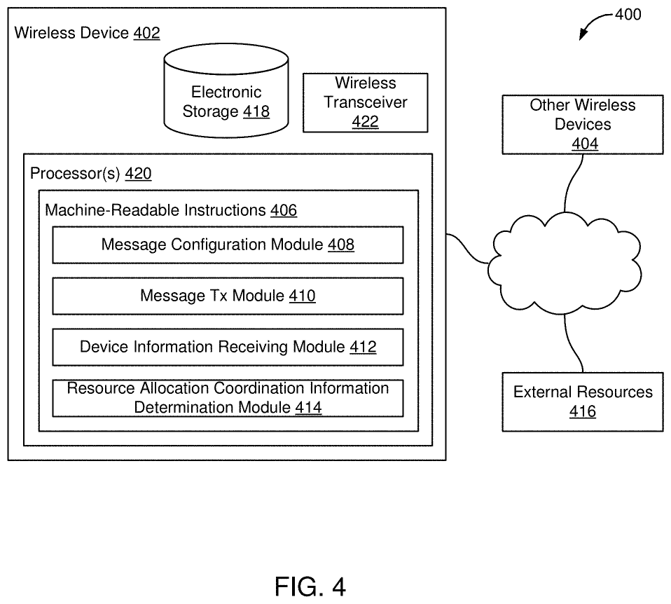

FIG. 4 is a component block diagram illustrating a system 400 configured for sidelink communications in accordance with various embodiments. In some embodiments, system 400 may include a wireless device 402 and/or one or more other wireless devices 404. With reference to FIGS. 1-4, examples of the wireless device 402 may include the wireless device 120a-120f, 200, 320). Other wireless device(s) 404 may include a roadside unit (RSU) or other wireless devices (e.g., the wireless device 120a-120f, 200, 320). The external resources 416 may include sources of information outside of the system 400, external entities participating with the system 400, and/or other resources. In some implementations, some or all of the functionality attributed herein to external resources 416 may be provided by resources included in the system 400.

Wireless device 402 may include a processor 420 coupled to a wireless transceiver 422 and configured by machine-readable instructions 406. Machine-readable instructions 406 may include one or more instruction modules. The instruction modules may include computer program modules. The instruction modules may include one or more of a message configuration module 408, a message transmission (Tx) module 410, a device information receiving module 412, a resource allocation coordination information determination module 414, and/or other instruction modules.

The message configuration module 408 may be configured to configure a message, which may be a control message, to include resource allocation coordination information, for example, to enable a second wireless device to avoid a sidelink communication resource collision. Configuring the message to include the resource allocation coordination information may include configuring a MAC-CE to include the determined resource allocation coordination information. Configuring the message to include the resource allocation coordination information may include configuring an SCI message to include the determined resource allocation coordination information.

The message configuration module 408 may be configured to configure the message, which may be a control message, to include a bitmap of available resources and occupied resources. The message configuration module 408 may be configured to configure the message to include one or more of a list of occupied resources or a list of available resources. The message configuration module 408 may be configured to configure the message to include one or more of a list of preferred resources for transmissions by the second wireless device to the wireless device, or a list of resources to avoid for transmissions by the second wireless device to the wireless device.

The message configuration module 408 may be configured to configure the message, which may be a control message, to include one or more of a location of the wireless device, a priority associated with the wireless device, or a timestamp indicating when the resource allocation coordination information was determined. The message configuration module 408 may be configured to configure the message to include per-resource information. By way of a non-limiting example, the information may include one or more of a signal strength measurement associated with a resource reservation, a source identifier associated with a resource reservation, a destination identifier associated with a resource reservation, a hybrid automatic repeat request identifier associated with a resource reservation, a priority associated with a resource reservation, a location of a transmitter reserving a resource, a reservation time period, or a demodulation reference signal pattern of a transmission associated with a resource reservation.

The message Tx module 410 may be configured to transmit the configured message including the resource allocation coordination information to the second wireless device.

The device information receiving module 412 may be configured to receive from a third wireless device information about a sidelink communication resource reservation made by the third wireless device.

The resource allocation coordination information determination module 414 may be configured to determine the resource allocation coordination information based on the information received from the third wireless device.

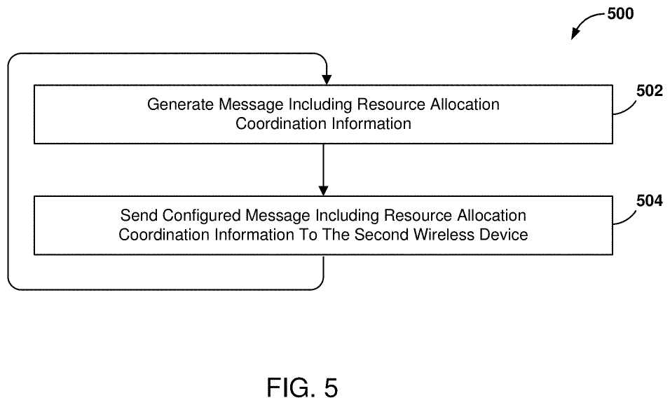

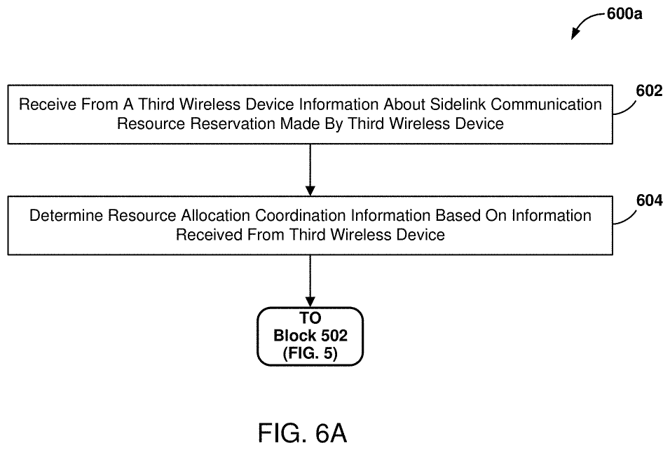

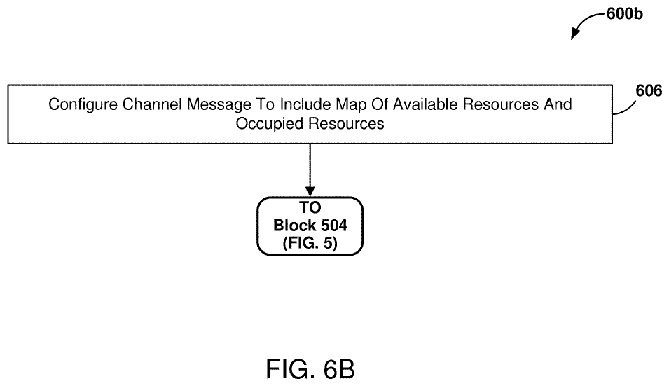

FIG. 5 is a process flow diagram illustrating a method of sidelink communications according to various embodiments. With reference to FIGS. 1-5, the operations of the method 500 may be performed by a processor of a wireless device for exchanging information for supporting sidelink communications. In some embodiments, such information may enable preventing or minimizing collisions on communication resources. The operations of the method 500 may be performed by a processor (such as the processor 210, 212, 214, 216, 218, 252, 260, 420) coupled to a wireless transceiver (e.g., 422) of a wireless device (such as the wireless device 120a-120f, 200, 320, 350, 402). For example, the operations of the method 500 may be performed by a processor of a road side unit (e.g., the road side unit 102f), vehicles (e.g., 102d and/or another wireless device (e.g., the wireless device 120a-120f, 200, 320) performing side link communications (e.g., V2X).

In block 502, the processor may configure a message, which may be a control message, to include resource allocation coordination information. The resource allocation coordination information may include indications of communication resources (e.g., time slots and channels) in side link communications that may be available for use in side link communications by another wireless device 404 (e.g., a road side unit, another vehicle, or other wireless device). Means for performing functions of the operations in block 502 may include the processor 420 and, or in conjunction with, a wireless transceiver 422 that may make power measurements in some embodiments to provide resource allocation coordination information.

In block 504, the processor may transmit the configured message including the resource allocation coordination information to the second wireless device via a message channel, which may be a control channel. Means for performing functions of the operations in block 504 may include the processor 210, 212, 214, 216, 218, 252, 260, 420 and a wireless transceiver 422 that transmits the message.

The processor may again perform the operations of block 502 as described to continuously or periodically providing resource allocation coordination information to other wireless devices.

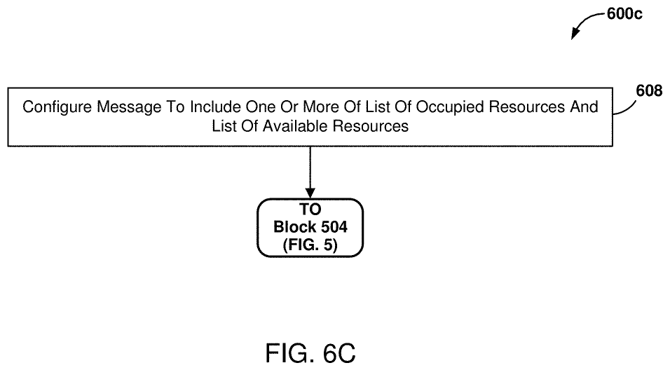

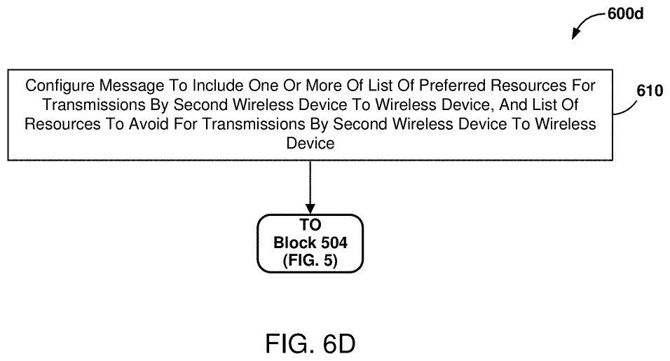

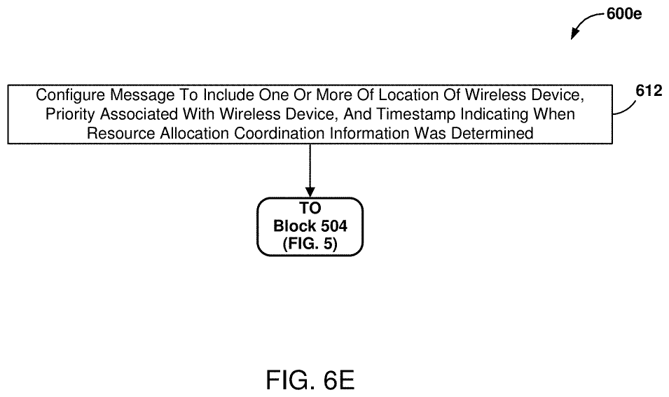

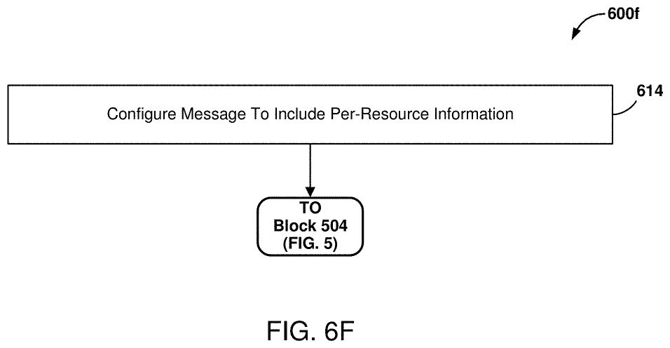

FIGS. 6A, 6B, 6C, 6D, 6E, and 6F are process flow diagrams illustrating operations 600a-600f that may be performed by a processor of a wireless device as part of the method 500 of sidelink communications according to various embodiments. With reference to FIGS. 1-6F, the operations 600a-600f may be performed by a processor (such as the processor 210, 212, 214, 216, 218, 252, 260, 420) of a wireless device (such as the wireless device 120a-120e, 200, 320, 402).

With reference to FIG. 6A, in block 602, the processor may receive from a third wireless device information about a sidelink communication resource reservation made by the third wireless device. Means for performing functions of the operations in block 602 may include the processor 210, 212, 214, 216, 218, 252, 260, 420 and a wireless transceiver 422 that receives the sidelink communication resource reservation messages and passes the messages to the processor.

In block 604, the processor may perform operations including determining the resource allocation coordination information based on the information received from the third wireless device. For example, the processor may determine that sidelink communication resources reserved by the third wireless device mean that if a second wireless device were to transmit on those same resources (e.g., time slots and channels) then a sidelink communication resource collision may occur, and transform this conclusion into resource allocation coordination information that would be useful by the second computing device (e.g., to avoid the sidelink communication resource collision). Means for performing functions of the operations in block 604 may include the processor 210, 212, 214, 216, 218, 252, 260, 420.

The processor may then perform the operations of the method 500 as described with reference to FIG. 5.

Referring to FIG. 6B, in block 606, the processor may configure the message, which may be a control channel message, to include a map of available resources and occupied resources. The map (e.g., a bitmap) may be configured to indicate with single bits (e.g., “1” or “0”) in a set pattern within a data element (e.g., one or more bytes) s that communicates available and/or occupied resources (i.e., a time slot and channel). For example, the message may be configured as one or more bytes that indicate with a “1” in a particular bit location that the corresponding resource is available; specifically that a second wireless device transmitting in that resource would not result in a collision that would prevent the first wireless device from receiving the message. As another example, the message may be configured as one or more bytes that indicate with a “1” in a particular bit location that the corresponding resource is not available such that a message transmitted in that resource may not be received by the first wireless device. Other bit pattern formats may be used in block 606. Means for performing functions of the operations in block 508 may include a processor 210, 212, 214, 216, 218, 252, 260, 420.

The processor may then perform the operations of block 504 of the method 500 as described with reference to FIG. 5.

Referring to FIG. 6C, in block 608, the processor may configure the message to include one or more of a list of occupied resources or a list of available resources. Means for performing functions of the operations in block 508 may include a processor 210, 212, 214, 216, 218, 252, 260, 420.

The processor may then perform the operations of block 504 of the method 500 as described with reference to FIG. 5.

Referring to FIG. 6D, in block 610, the processor may configure the message to include one or more of a list of preferred resources for transmissions by the second wireless device to the wireless device, or a list of resources to avoid for transmissions by the second wireless device to the wireless device. Means for performing functions of the operations in block 508 may include a processor 210, 212, 214, 216, 218, 252, 260, 420.

The processor may then perform the operations of block 504 of the method 500 as described with reference to FIG. 5.

Referring to FIG. 6E, in block 612, the processor may configure the message to include one or more of a location of the wireless device, a priority associated with the wireless device, or a timestamp indicating when the resource allocation coordination information was determined. Means for performing functions of the operations in block 608 may include a processor 210, 212, 214, 216, 218, 252, 260, 420.

The processor may then perform the operations of block 504 of the method 500 as described with reference to FIG. 5.

Referring to FIG. 6F, in block 614, the processor may configure the message to include per-resource information. The information may include one or more of a signal strength measurement associated with a resource reservation, a source identifier associated with a resource reservation, a destination identifier associated with a resource reservation, a hybrid automatic repeat (HARQ) request identifier associated with a resource reservation, a priority associated with a resource reservation, a location of a transmitter reserving a resource, a reservation time period, or a demodulation reference signal (DMRS) pattern of a transmission associated with a resource reservation. Means for performing functions of the operations in block 614 may include a processor 210, 212, 214, 216, 218, 252, 260, 420.

The processor may then perform the operations of block 504 of the method 500 as described with reference to FIG. 5.

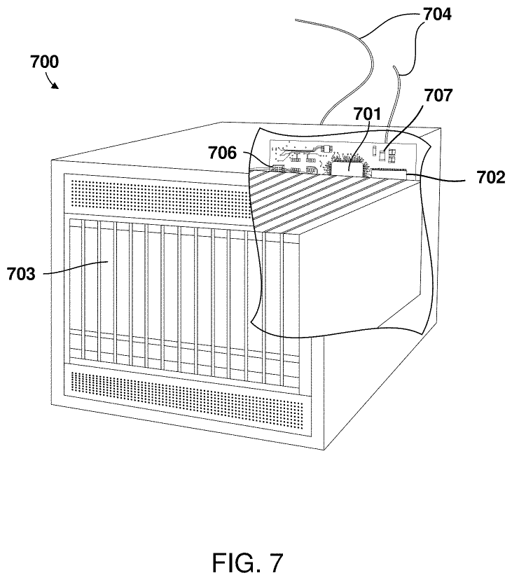

Various embodiments may be implemented on a variety of wireless network devices, an example of which is illustrated in FIG. 7 in the form of a roadside unit 700. Such network computing devices may include at least the components illustrated in FIG. 7. With reference to FIGS. 1-7, the roadside unit 700 may typically include a processor 701 coupled to volatile memory 702 and a large capacity nonvolatile memory, such as a disk drive 703. The roadside unit 700 may also include a peripheral memory access device such as a floppy disc drive, compact disc (CD) or digital video disc (DVD) drive 706 coupled to the processor 701. The roadside unit 700 may also include network access ports 704 (or interfaces) coupled to the processor 701 for establishing data connections with a network, such as the Internet and/or a local area network coupled to other system computers and servers. The roadside unit 700 may include one or more antennas 707 for transmitting and receiving electromagnetic radiation that may be connected to a wireless communication link. The roadside unit 700 may include additional access ports, such as USB, Firewire, Thunderbolt, and the like for coupling to peripherals, external memory, or other devices.

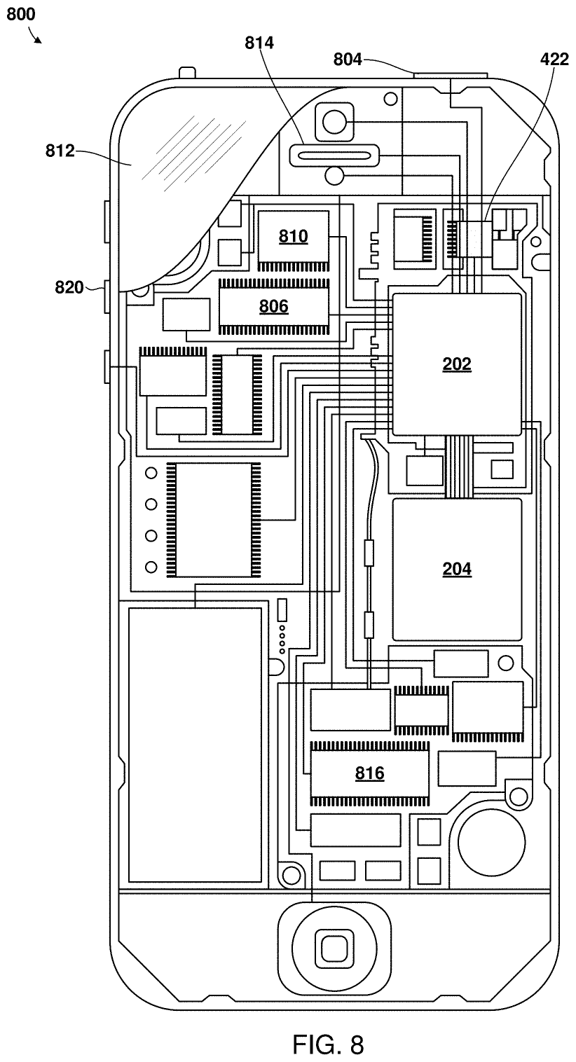

Various embodiments may be implemented on a variety of wireless devices (e.g., the wireless device 120a-120f, 200, 320), an example of which is illustrated in FIG. 8 in the form of a smartphone 800. The smartphone 800 may include a first SOC 202 (e.g., a SOC-CPU) coupled to a second SOC 204 (e.g., a 5G capable SOC). The first and second SOCs 202, 204 may be coupled to internal memory 806, 816, a display 812, and to a speaker 814. Additionally, the smartphone 800 may include an antenna 804 for transmitting and receiving electromagnetic radiation that may be connected to a wireless data link and/or cellular telephone transceiver 422 coupled to one or more processors in the first and/or second SOCs 202, 204. Smartphones 800 typically also include menu selection buttons or rocker switches 820 for receiving user inputs.

A typical smartphone 800 also includes a sound encoding/decoding (CODEC) circuit 810, which digitizes sound received from a microphone into data packets suitable for wireless transmission and decodes received sound data packets to generate analog signals that are provided to the speaker to generate sound. Also, one or more of the processors in the first and second SOCs 202, 204, wireless transceiver 422 and CODEC 810 may include a digital signal processor (DSP) circuit (not shown separately).

The processors of the roadside unit 700 and the smart phone 800 may be any programmable microprocessor, microcomputer or multiple processor chip or chips that can be configured by software instructions (applications) to perform a variety of functions, including the functions of the various embodiments described below. In some wireless devices, multiple processors may be provided, such as one processor within an SOC 204 dedicated to wireless communication functions and one processor within an SOC 202 dedicated to running other applications. Typically, software applications may be stored in the memory 806, 816 before they are accessed and loaded into the processor. The processors may include internal memory sufficient to store the application software instructions.

As used in this application, the tell is “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a wireless device and the wireless device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 500 and 600a-600f may be substituted for or combined with one or more operations of the methods 500 and 600a-600f.

Implementation examples are described in the following paragraphs. While some of the following implementation examples are described in terms of example methods, further example implementations may include: a processor configured with processor-executable instructions to perform operations of the methods of the implementation examples discussed in the following paragraphs; a wireless device including means for performing functions of the methods of the implementation examples discussed in the following paragraphs; and a non-transitory processor-readable storage medium having stored thereon processor-executable instructions configured to cause a processor of a wireless device to perform the operations of the methods of the implementation examples discussed in the following paragraphs.

### EXAMPLE 1

A method of sidelink communications performed by a wireless device including: generating a message including resource allocation coordination information; and transmitting the message including the resource allocation coordination information to a second wireless device.

### EXAMPLE 2

The method of example 1, in which generating the message to include the resource allocation coordination information includes generating a Medium Access Control (MAC) control element (CE) that includes the resource allocation coordination information.

### EXAMPLE 3

The method of any of examples 1 and 2, in which generating the message including the resource allocation coordination information includes configuring a Sidelink Control Information (SCI) message to include the resource allocation coordination information.

### EXAMPLE 4

The method of any of examples 1-3, further including: receiving, from a third wireless device, information about a sidelink communication resource reservation made by the third wireless device; and determining the resource allocation coordination information based on the information received from the third wireless device.

### EXAMPLE 5

The method of any of examples 1-4, in which generating the message including the resource allocation coordination information includes configuring the message to include a map of available resources and occupied resources.

### EXAMPLE 6

The method of any of examples 1-5, in which generating the message including the resource allocation coordination information includes configuring the message to include one or more of a list of occupied resources or a list of available resources.

### EXAMPLE 7

The method of any of examples 1-6, in which generating the message including the resource allocation coordination information includes configuring the message to include one or more of a list of preferred resources for transmissions by the second wireless device to the wireless device, or a list of resources to avoid for transmissions by the second wireless device to the wireless device.

### EXAMPLE 8

The method of any of examples 1-7, in which generating the message including the resource allocation coordination information includes configuring the message to include one or more of a location of the wireless device, a priority associated with the wireless device, or a timestamp indicating when the resource allocation coordination information was determined.

### EXAMPLE 9

The method of any of examples 1-8, in which generating the message including the resource allocation coordination information includes configuring the message to include per-resource information comprising one or more of: a signal strength measurement associated with a resource reservation; a source identifier associated with a resource reservation; a destination identifier associated with a resource reservation; a hybrid automatic repeat request (HARQ) identifier associated with a resource reservation; a priority associated with a resource reservation; a location of a transmitter reserving a resource; a reservation time period; or a demodulation reference signal (DMRS) pattern of a transmission associated with a resource reservation.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of sidelink communications performed by a wireless device, comprising:
generating a message including resource allocation coordination information; and
transmitting the message including the resource allocation coordination information to a second wireless device.

2. The method of claim 1, wherein generating the message to include the resource allocation coordination information comprises generating a Medium Access Control (MAC) control element (CE) that includes the resource allocation coordination information.

3. The method of claim 1, wherein generating the message including the resource allocation coordination information comprises configuring a Sidelink Control Information (SCI) message to include the resource allocation coordination information.

4. The method of claim 1, further comprising:
receiving, from a third wireless device, information about a sidelink communication resource reservation made by the third wireless device; and
determining the resource allocation coordination information based on the information received from the third wireless device.

5. The method of claim 1, wherein generating the message including the resource allocation coordination information comprises configuring the message to include a map of available resources and occupied resources.

6. The method of claim 1, wherein generating the message including the resource allocation coordination information comprises configuring the message to include one or more of a list of occupied resources or a list of available resources.

7. The method of claim 1, wherein generating the message including the resource allocation coordination information comprises configuring the message to include one or more of a list of preferred resources for transmissions by the second wireless device to the wireless device, or a list of resources to avoid for transmissions by the second wireless device to the wireless device.

8. The method of claim 1, wherein generating the message including the resource allocation coordination information comprises configuring the message to include one or more of a location of the wireless device, a priority associated with the wireless device, or a timestamp indicating when the resource allocation coordination information was determined.

9. The method of claim 1, wherein generating the message including the resource allocation coordination information comprises configuring the message to include per-resource information comprising one or more of:
a signal strength measurement associated with a resource reservation;
a source identifier associated with a resource reservation;
a destination identifier associated with a resource reservation;
a hybrid automatic repeat request (HARQ) identifier associated with a resource reservation;
a priority associated with a resource reservation;
a location of a transmitter reserving a resource;
a reservation time period; or
a demodulation reference signal (DMRS) pattern of a transmission associated with a resource reservation.

10. A wireless device, comprising:
a transceiver; and
a processor coupled to the transceiver and configured to:
generate a message including resource allocation coordination information; and
transmit the message including the resource allocation coordination information to a second wireless device.

11. The wireless device of claim 10, wherein the processor is further configured to generate a Medium Access Control (MAC) control element (CE) that includes the resource allocation coordination information.

12. The wireless device of claim 10, wherein the processor is further configured to configure a Sidelink Control Information (SCI) message to include the resource allocation coordination information.

13. The wireless device of claim 10, wherein the processor is further configured to:
receive, from a third wireless device, information about a sidelink communication resource reservation made by the third wireless device; and
determine the resource allocation coordination information based on the information received from the third wireless device.

14. The wireless device of claim 10, wherein the processor is further configured to configure the message to include a map of available resources and occupied resources.

15. The wireless device of claim 10, wherein the processor is further configured to configure the message to include one or more of a list of occupied resources or a list of available resources.

16. The wireless device of claim 10, wherein the processor is further configured to configure the message to include one or more of a list of preferred resources for transmissions by the second wireless device to the wireless device, or a list of resources to avoid for transmissions by the second wireless device to the wireless device.

17. The wireless device of claim 10, wherein the processor is further configured to configure the message to include one or more of a location of the wireless device, a priority associated with the wireless device, or a timestamp indicating when the resource allocation coordination information was determined.

18. The wireless device of claim 10, wherein the processor is further configured to configure the message to include per-resource information comprising one or more of:
a signal strength measurement associated with a resource reservation;
a source identifier associated with a resource reservation;
a destination identifier associated with a resource reservation;
a hybrid automatic repeat request (HARQ) identifier associated with a resource reservation;
a priority associated with a resource reservation;
a location of a transmitter reserving a resource;
a reservation time period; or
a demodulation reference signal (DMRS) pattern of a transmission associated with a resource reservation.

19. A wireless device, comprising:
means for generating a message including resource allocation coordination information; and
means for transmitting the message including the resource allocation coordination information to a second wireless device.

20. The wireless device of claim 19, wherein means for generating the message to include the resource allocation coordination information comprises means for generating a Medium Access Control (MAC) control element (CE) that includes the resource allocation coordination information.

21. The wireless device of claim 19, wherein means for generating the message including the resource allocation coordination information comprises means for configuring a Sidelink Control Information (SCI) message to include the resource allocation coordination information.

22. The wireless device of claim 19, further comprising:
means for receiving, from a third wireless device, information about a sidelink communication resource reservation made by the third wireless device; and
means for determining the resource allocation coordination information based on the information received from the third wireless device.

23. The wireless device of claim 19, wherein means for generating the message including the resource allocation coordination information comprises means for configuring the message to include a map of available resources and occupied resources.

24. The wireless device of claim 19, wherein means for generating the message including the resource allocation coordination information comprises means for configuring the message to include one or more of a list of occupied resources or a list of available resources.

25. The wireless device of claim 19, wherein means for generating the message including the resource allocation coordination information comprises means for configuring the message to include one or more of a list of preferred resources for transmissions by the second wireless device to the wireless device, or a list of resources to avoid for transmissions by the second wireless device to the wireless device.

26. The wireless device of claim 19, wherein means for generating the message including the resource allocation coordination information comprises means for configuring the message to include one or more of a location of the wireless device, a priority associated with the wireless device, or a timestamp indicating when the resource allocation coordination information was determined.

27. The wireless device of claim 19, wherein means for generating the message including the resource allocation coordination information comprises means for configuring the message to include per-resource information comprising one or more of:
a signal strength measurement associated with a resource reservation;
a source identifier associated with a resource reservation;
a destination identifier associated with a resource reservation;
a hybrid automatic repeat request (HARQ) identifier associated with a resource reservation;
a priority associated with a resource reservation;
a location of a transmitter reserving a resource;
a reservation time period; or
a demodulation reference signal (DMRS) pattern of a transmission associated with a resource reservation.

28. A non-transitory processor-readable medium having stored thereon processor-executable instruction configured to cause a processing device in a wireless device to perform operations comprising:
generating a message including resource allocation coordination information; and
transmitting the message including the resource allocation coordination information to a second wireless device.

29. The non-transitory processor-readable medium of claim 28, wherein the stored processor-executable instructions are configured to cause a processor of a wireless device to perform operations such that generating the message including the resource allocation coordination information comprises configuring a Sidelink Control Information (SCI) message to include the resource allocation coordination information.

30. The non-transitory processor-readable medium of claim 29, wherein the stored processor-executable instructions are configured to cause a processor of a wireless device to perform operations further comprising:
receiving, from a third wireless device, information about a sidelink communication resource reservation made by the third wireless device; and
determining the resource allocation coordination information based on the information received from the third wireless device.
